(19) United States
(12) Patent Application Publication
(10) Pub. No.: US 2009/0197106 A1
(43) Pub. Date: Aug. 6, 2009

(54) Compact laminate

(76) Inventor: Joel Klippert, Puyallup, WA (US)

Correspondence Address: CHARLES J RUPNICK, PO BOX 46752, SEATTLE, WA, 98146, US

(21) Appl. No.: 12/012,081

(22) Filed: Jan. 31, 2008

(51) Int. Cl. B32B 27/10; B32B 27/42

(52) U.S. Cl. 428/503; 428/533; 428/501

(57) ABSTRACT

A compact laminated assembly based upon a saturation grade paper made using a grass fiber or grass/wood fiber blend, instead of the conventional wood fibers from trees. A plurality of the grass paper sheets are substantially impregnated using a thermosetting resin and stacked in a superimposed relationship. The assembled stack of resin impregnated paper sheets are heat and pressure consolidated into a substantially homogenous monolithic mass with the thermosetting resin being substantially completely cured.

### FIELD OF THE INVENTION

The present invention relates generally to both low and high pressure bio-composite surface resin laminate materials and methods for producing same, and in particular to resin laminates formed of grass fiber and blends of grass fiber with recycled wood fiber, including wood fiber from recycled paper products.

### BACKGROUND OF THE INVENTION

Compact laminates are generally well-known as made up of multiple layers of kraft paper impregnated with thermosetting phenolic resin sandwiched between decor papers impregnated with special high-abrasion-resistant melamine resins. These components are pressed at a temperature and pressure at which a chemical and physical transformation known as polymerization occurs where the components are melded into an extremely strong, solid, homogenous panel with superior wear-resistance, but suitable for internal use only.

Both low pressure and high pressure resin methods are generally well-known for producing compact laminates. One low pressure resin laminate is disclosed by DeLapp in U.S. Pat. No. 4,109,043, “Low Pressure Melamine Resin Laminates” issued Aug. 22, 1978, which is incorporated herein by reference, which discloses a heat and pressure consolidated structure formed of a self-supporting substrate in superimposed relationship with a decorative alpha-cellulose paper sheet that is impregnated with a resin composition of a mixture of a melamine/formaldehyde resin syrup, an elastomer comprising an ethylene/vinyl chloride copolymer containing amide groups, a butadiene/acrylonitrile copolymer containing carboxyl groups or a polyurethane resin containing carboxyl groups and an alkylene polyamine.

As disclosed by DeLapp, the compositions may be used to produce a transparent system, for example, in the production of decorative panels of a specific color or having a specific decorative pattern or design on the decorative layer.

As also disclosed by DeLapp, the decorative papers from which the low-pressure decorative panels are produced are made from bleached wood pulp which is high, at least about 60%, in alpha cellulose content.

The decorated paper layer may be placed on both sides or only on one side of the self-supporting substrate when panels are being produced. If the decorative sheet is placed only on one side of the substrate, a so-called balance sheet, i.e., a melamine/formaldehyde resin impregnated paper sheet, e.g., of kraft or other paper, sometimes called a cabinet liner, can be placed on the other side in order to prevent the resultant panel from warping during pressing. Typical release sheets can be applied to both the decorative paper layer and the balance sheet to prevent the press plate from sticking thereto during pressing.

DeLapp teaches that various finishes may be applied to the decorative panels. For example, the surface may be rendered glossy by using a highly polished press plate, matte by interposing a texturizing release sheet between the press plate and the decorative sheet or embossed by using an etched press plate.

In U.S. Pat. No. 4,128,696, “Low Pressure Melamine Resin Laminates” issued Dec. 5, 1978, which is incorporated herein by reference, Goebel, et al. discloses a heat and pressure consolidated panel composed of, in superimposed relationship, (A) a self-supporting substrate, and (B) a decorative alpha-cellulose paper sheet impregnated with a composition formed of (1) a blend of an aqueous melamine/formaldehyde resin solution and from about 2% to about 20.0% of an ethylene glycol or (2) an aqueous solution of the resinous reaction product of melamine, formaldehyde and from about 2.0% to about 20.0% of an ethylene glycol.

According to Goebel, et al., these panels are a single sheet of melamine/formaldehyde resin impregnated decorative paper which is bonded under heat and pressure to a substrate, usually particle-board, of about ¼ to about 1 inch in thickness. Goebel, et al. also discloses that these products, because they are normally produced at low pressures, i.e., about 175-to-225 psi to as much as 300 psi, and low temperatures, i.e., about 325 degree F. to 350 degree F., at very short cure cycles in the range of 2 to 3 minutes, are relatively inexpensive and have a good appearance and stain resistance.

Alternatively, high pressure resin laminates and methods of producing same are disclosed by Albrinck, et al. in U.S. Pat. No. 5,288,540, “Damage Resistant Decorative Laminate Having Excellent Appearance And Cleanability And Methods Of Producing Same” issued Feb. 22, 1994, which is incorporated herein by reference, which relates to damage resistant, decorative laminates employing a decorative sheet saturated with a melamine/formaldehyde resin coating incorporating abrasive materials and methods of producing the same. See, also, U.S. Pat. No. 4,255,480, “Abrasion-Resistant Laminate” issued Mar. 10, 1981, which is incorporated herein by reference, in which Scher, et al. disclose an abrasion-resistant laminate is prepared by providing an ultra thin coating of mineral particles and micro crystalline cellulose on the surface of conventional printed paper, followed by impregnating the paper with a conventional laminating resin, and then using the print paper so obtained in a laminating process without the necessity of using an overlay sheet.

As disclosed by both Albrinck, et al. and Scher, et al., conventional high pressure decorative laminates are produced by stacking and curing under heat and pressure a plurality of layers of paper impregnated with various synthetic thermosetting resins. High pressure decorative laminates consist of two essential layers: a core layer and a surface layer. The core layer constitutes a bottom or supporting layer onto which the other layer is bonded. In normal high-pressure laminate manufacture, the core layer consists of a plurality of cellulosic sheets, e.g. three to eight, core sheets.

As further disclosed by Albrinck, et al., other laminating resins commonly used for the core layer include phenolic, amino, epoxy, polyester, silicone, and diallyl phthalate resins to name a few. The industrially preferred laminating resin for decorative laminates is a phenolic resin made from the reaction of phenols with formaldehyde. Placed above the core layer is a decorative layer which is generally an alpha cellulose pigmented paper containing a print, pattern design or solid color that has been impregnated with a thermosetting resin, such as a melamine/formaldehyde resin. The cured thermosetting resins are colorless and resistant to light; they are resistant to a variety of solvents and stains; and their heat resistance make them resistant to burning cigarettes, boiling water and heated containers up to about 325 degree F.

When the decorative layer of the laminate is a printed pattern, it is often covered with an overlay as it is commonly referred to, which is a high-quality alpha cellulose paper impregnated with a melamine/formaldehyde resin. This overlay is almost transparent and protects the decorative print from external abuse such as abrasive wear and tear, harsh chemicals, burns, spills and the like. It is primarily the melamine/formaldehyde resin which accounts for these protective properties of the laminate. The alpha-cellulose paper acts as a translucent carrier for the water-thin resin, imparts strength to the rather brittle melamine/formaldehyde resin, maintains a uniform resin thickness in the overlay by acting as a shim, and controls resin flow.

The core sheets are generally made from a kraft paper of about 90-125 pound ream weight. Kraft paper is manufactured from normal high quality soft wood sulphate pulp, as disclosed by Landqvist, et al. in U.S. Pat. No. 4,741,376, “Manufacturing Of Kraft Paper” issued May 3, 1988, which is incorporated herein by reference. Prior to stacking, the kraft paper is impregnated with a laminating resin such as a water-alcohol solution of phenol/formaldehyde resole, dried and partially cured in a hot air oven, and finally cut into sheets. The print sheet is a high quality, 50-125 ream weight, pigment filled, alpha cellulose paper that has been impregnated with a water-alcohol solution of melamine/formaldehyde resin, dried and partially cured, and finally cut into sheets. The print sheet, prior to impregnation with the resin, usually has been printed with a decorative design, or with a photogravure reproduction of natural materials, such as wood, marble, leather, etc.

The overlay sheet is almost invariably used when the print or pattern sheet has a surface printing in order to protect the printing from abrasive wear. The overlay sheet is a high quality bleached wood pulp paper of high alpha cellulose content, typically of about 20-30 pounds ream weight, that is also impregnated with melamine/formaldehyde resin in a manner similar to that used for the print sheet, except that a greater amount of resin per unit weight of paper is used. The individual pattern sheets are stacked in the manner indicated above and, if six sheets of impregnated core paper are used, there results a finished laminate having a thickness of about 50 mils, although a different number of sheets can be used to provide thicker or thinner laminates.

The core layer, decorative layer and the overlay surface layer (when present) are stacked from the bottom up in a superimposed relationship, between steel press plates and subjected to heat, pressure and temperature for a time period sufficient to consolidate the laminate and to cure the laminating resins impregnating the respective layers. The elevated temperature and pressure actually cause the impregnated resins within the sheets to flow, cure and consolidate the sheets into a unitary laminated mass referred to in the art as a decorative high-pressure laminate. At the completion of the laminating operation, the backs of the laminates are sanded to permit gluing to particle board, plywood or other substrates. The glued, laminate surfaced panels are used as surfacings for counter tops, table tops, furniture, store fixtures and the like. However, these conventional high pressure laminates can be easily damaged by scraping or marring caused by objects sliding across the surface of the laminate.

A number of variations of the above-described general processes are known, particularly those operations designed to obtain special effects in appearance and texture. Also various curing cycles are possible and, in fact, sometimes other resin systems are used as well.

As illustrated by these and other prior art patents, both high-pressure and low-pressure decorative resin laminate panels and known methods for producing same are limited to a decorative paper layer stacked in a superimposed relationship with a core layer and an optional protective surface layer. The core layers are generally made from a kraft paper manufactured from normal high quality soft wood sulphate pulp, and the decorative papers are made from bleached wood pulp. Known resin laminate panels are thus limited to products made from wood fibers.

According to Scher, et al., it is desirable to be able to provide the characteristics of an abrasion-resistant high-pressure laminate, but without using an overlay, for several reasons. Overlay adds substantial raw material costs to the manufacture of laminates, both the cost of the overlay paper itself, the cost of the resin used to impregnate the overlay paper and the in-process and handling of losses of these materials.

The overlay, by imposing an intermediate layer of substantial thickness between the print sheet and the eyes of the viewer, detracts significantly from the desired visual clarity of the pattern. The cellulose fibers used to make overlay paper have a refractive index close to that of cured melamine/formaldehyde resin. The fibers are therefore almost invisible in the cured laminate, and permit the printed pattern to be seen with very little attenuation. However, modern printing techniques are making available very accurate reproductions of natural materials, particularly various wood veneer species. As these printed reproductions approach in appearance the natural veneer, even small amounts of haze or blur introduced by the overlay paper are disturbing visually and destroy much of the realism desired by the user.

Furthermore, the overlay contributes to the rejection rate of the laminate products produced. The impregnated, dry overlay sheet tends to attract small dirt particles because it develops static electricity charges during drying. This dirt is hard to detect and remove before laminating, and results in spoiled laminate sheets that cannot be reprocessed. In addition, the impregnated dried overlay is brittle and hard to handle without breakage. Broken pieces are accidentally trapped on the surface of the overlay and also result in visually defective sheets.

Additionally, laminates containing an overlay, particularly those having a relatively high surface gloss, have a tendency to become dull very quickly when subjected even to only moderate abrasive wear. This is understandably unacceptable where glossy laminates are desired.

Although as discussed herein above, Scher, et al. also disclose an abrasion-resistant high-pressure laminate without the necessity of using an overlay sheet, overlay sheets remain common practice.

### SUMMARY OF THE INVENTION

The present invention is a novel thermal set resin compact laminate product using a grass fiber, such as a bamboo fiber, instead of the conventional wood fibers from trees. The bamboo grass fiber is much longer and more absorbent than traditional tree fiber, characteristics which provide the unexpected results of greater dimensional stability and a stronger internal bond due to an increased resin saturation into the core over conventional wood fiber alone. The novel paper product of the present invention utilizes either 100% bamboo or other grass fibers, a rapidly renewable resource, or a 50/50 blend of grass and recycled wood fiber, including wood fiber from recycled paper products. These results are unexpected because grass fibers, including bamboo fibers, have not previously been used in thermal set resin paper products.

According to one aspect of the invention, the novel thermal set resin paper product is based upon a novel saturation grade paper made using the grass fiber or grass/wood fiber blend. The novel paper is saturated with a thermosetting resin, including but not limited to any phenolic, epoxy, melamine or polyester laminating resin. The laminating resin is optionally an environmentally friendly 100% water-based melamine resin.

After the paper fiber is treated with resin, the product is pressed and bonded together under heat and pressure. According to one aspect of the invention, the heat and pressure are applied using a high pressure press at approximately 1,000 psi to 1,200 psi at approximately 275 degrees F. to cure the resin, then using a cooling cycle the press is cooled to about 100 degrees F. while the product is still under pressure. Continued application of the pressure retards warp while cooling are ensures the resultant panels are flat. When the panel product is manufactured utilizing a low pressure press without a cooling cycle, more resin is used than in the comparable high pressure process, and pressures between about 200 psi and 300 psi are utilized. The laminated panel product is optionally removed hot from the press, and stacked on a cooling slab under heavy load to maintain flatness, while being cooled with fans.

After cooling, the resultant laminates are separated, trimmed and packaged.

Other aspects of the invention are detailed herein.

### DETAILED DESCRIPTION OF PREFERRED EMBODIMENT

A novel compact laminate is disclosed that utilizes a novel saturation grade paper made from a grass fiber, such as a bamboo or other grass fiber, either alone or in a blend, e.g., about a 50/50 blend, of grass and wood fiber. The wood fiber is either a virgin wood fiber or a recycled wood fiber, for example a wood fiber salvaged from demolition sites, or wood fiber salvaged from recycled paper and recycled paper products. The grass fiber is much longer and more absorbent than traditional tree fiber. These are characteristics that produce unexpected useful result when used in the present compact laminate. The longer grass fiber unexpectedly results in greater dimensional stability over the shorter traditional tree fiber. The longer grass fiber unexpectedly results in increased resin saturation into the product core over the shorter traditional tree fiber, which increased resin saturation results in a stronger internal bond than is typical of conventional compact laminates traditional tree fiber. The use of grass fiber thus unexpectedly permits thicker compact laminates than are possible when the paper is prepared from traditional tree fiber. Thus, although the novel compact laminate disclosed herein is optionally produced as a thin decorative surface layer and assembled in superimposed relationship with a self-supporting bottom or substrate layer such as particle board or plywood substrates or the conventional cores layer described herein, it is optionally produced in much thicker sections capable of standing alone, without the necessity of the bottom or supporting core layer onto which the conventional decorative layer is traditionally bonded. Accordingly, the novel compact laminate disclosed herein is optionally produced as thin decorative surface layers from about 0.040 inch thick through thicker self-supporting panels of ¼ inch thickness up to 1-½ inch thickness or even thicker. Thus, while the novel compact laminate disclosed herein is optionally utilized as a decorative surface layer in the traditional manner, it is also used as a stand-alone product for counter tops, table tops, furniture, store fixtures and the like.

Furthermore, the composition of the novel compact laminate disclosed herein is a homogeneous composition having a substantially constant composition throughout any thickness. Therefore, abrasion resistance is not a factor. The decorative appearance and texture of prior art compact laminates are present only in the thin decorative sheet that is easily damaged and thereafter irreparable. Any damage to the topmost decorative sheet exposes the phenolic resin core similarly to the way a scratch in the paint of an automobile exposes the metal beneath. Except, in the case of conventional compact laminates, the damage cannot be repaired sanding and repainting, but only by replacing the entire panel. For this reason, prior art compact laminates superimpose the clear protective layer to protect the integrity of the delicate decorative layer. Else, additives are supplied in the laminating resin syrup to improve abrasion resistance.

In contrast to the common practices of conventional compact laminates, the composition of the novel compact laminates disclosed herein is produced without the abrasion-resistant overlay surface layer or resin additives usually needed for protection against external abuse such as abrasive wear and tear, harsh chemicals, burns, spills and the like. Rather, the homogeneous nature of the compact laminates disclosed herein ensures that, in contrast to prior art compact laminates, the surface can be cut, routed, sanded and finished with typical woodworking tools, much like butcher block type surfaces, so that scratches, dents, burns and other surface damage can be repaired, for example, by sanding and refinishing. Furthermore, the homogeneous nature of the compact laminates disclosed herein ensures that digs, gouges, cuts and tears in the surface expose only the same color and texture extant in the surface layer so that damage, if it does occur, is not so readily apparent. Accordingly, the negative impacts of the overlay sheet typical of the prior art products are completely eliminated in the present compact laminate, without sacrificing the desirable durable qualities.

The above results are unexpected because grass fiber, and in particular bamboo fiber, has not previously been used in this type of compact laminate.

Optionally, a protective overlay is provided for obtaining particular characteristics not imparted by the laminating resin. By example and without limitation, the novel compact laminate disclosed herein further includes a protective layer of type that affords UV protection from fading and sun damage or another desirable environmental protection not afforded by the laminating resin.

The novel saturation grade paper made of the grass fiber or grass fiber/wood fiber blend is impregnated with resin. The most common types of laminating resin for use in producing the novel compact laminate are phenolic, epoxy, melamine and polyester. Epoxy may be the most durable resin. Other laminating resins that may be useful in practicing the novel compact laminate disclosed herein include but are not limited to amino, silicone, and diallyl phthalate resins to name a few. A thermosetting resin, either of melamine, phenolic or another thermosetting resin, such as urea, is optionally utilized. As discussed in the prior art, the industrially preferred laminating resin for decorative laminates is a phenolic resin made from the reaction of phenols with formaldehyde. The thermosetting resin composition may optionally be any of a phenol/formaldehyde resin, a melamine/formaldehyde resin, a urea/formaldehyde resin or mixtures thereof, as disclosed in U.S. Pat. No. 6,773,799, which is incorporated herein by reference. Alternatively, the laminating resin may optionally be a composition of one of the thermosetting resins with an elastomer and optionally incorporating an alkylene polyamine into the resin-elastomer mixture, as disclosed for example in U.S. Pat. No. 4,109,043, which is incorporated herein by reference.

Another laminating resin that may be useful in practicing the novel compact laminate disclosed herein is an acrylic resin-melamine/formaldehyde resin composition, as disclosed for example by Power, et al. in U.S. Pat. No. 3,983,307, “Thin, Tough, Stable Laminate” issued Sep. 28, 1976, which is incorporated herein by reference.

Optionally, a resin system or “syrup” of water-alcohol solution of phenol/formaldehyde with solvents may be utilized. Still another laminating resin that may be useful in practicing the novel compact laminate disclosed herein is 100 percent water-based melamine/formaldehyde resin system. Else, an aqueous melamine/formaldehyde resin solution with other additives may be utilized.

The laminating resin syrups useful herein are well known to those skilled in the art.

The novel saturation grade paper made of the grass fiber or grass fiber/wood fiber blend is impregnated with the curable laminating resin composition by any conventional method, e.g., dip-, brush-, flow-, roller- or spray-coating. Although the longer grass fiber unexpectedly results in increased resin saturation into the product core over the shorter traditional tree fiber, special impregnating techniques are not required over conventional impregnating methods used with the shorter traditional tree fiber.

The desired degree of impregnation can be achieved by one or several treating passes. As can be readily appreciated, where several treating passes are made, the solids content of the impregnating solution can be low; while for one-pass operations, the solids content will be higher.

Following impregnation, the grass or grass blend sheet is dried or cured as it is commonly referred to, to drive off volatiles before the entire laminating assembly is consolidated in a laminating press. Drying is accomplished at a temperature high enough so that substantially all of the inert organic solvent will be driven off, and yet low enough so that the curable resinous impregnant will not be so substantially advanced in cure that it will not exhibit satisfactory flow under the relatively high pressures encountered in the subsequent laminating step. The curable resinous impregnant thus will flow sufficiently to eliminate small pits, dents and other minor imperfections in the resinous layer.

However, a certain amount of advancement is desirable prior to the time at which the entire laminating assembly is consolidated in a laminating press, inasmuch as this insures that the curable resinous composition will not be squeezed out of the sheet in the press before being substantially completely cured to a solid or “C” stage. Furthermore, since cross-linking takes place fairly rapidly at temperatures above about 100 degrees C., it is evident that any desired degree of advancement can be accomplished either during the drying step, if drying is carried out at sufficiently elevated temperatures, or by an additional heating period at temperatures substantially above room temperature, if drying is carried out at relatively lower temperatures, e.g., room temperature.

The laminating resin is cured in the drying process to a volatile level appropriate to the pressing conditions present in the practice of the invention. The volatile level appropriate for use in a low pressure process is different from that for use in a high pressure process. Furthermore, utilizing only a hot press as opposed to a hot/cold press adds another variable to the process: the appropriate volatile level for a process utilizing a hot/cold press is different from that for a process utilizing only a hot press.

Accordingly, the drying process is selected as a function of pressing conditions such that the laminating resin is dried or cured to a “B” stage as it is commonly referred to, which advances the resin to about a half cured state.

The resultant sheets, i.e., the impregnated grass or grass blend sheet or a plurality of the impregnated sheets are then assembled, in superimposed relationship, each with its coated side on top and facing the adjacent sheet next above. The resultant assembly is then heat and pressure consolidated in conjunction with many more of such assemblies in a manner known in the art to produce the desired laminates.

The assemblies are then pressed in a manner typical of either a conventional high pressure compact laminate or a low pressure laminate. For example, in a high pressure process the assemblies are placed between cold rolled steel plates and inserted in a conventional high pressure hydraulic press and heated to about 275 to 300 degree F. and about 1,000 psi to 1,200 psi and up to about 1,400 psi for a predetermined period, for example, about 15 minutes, to cure the laminating resin. Practice of the present novel compact laminate optionally utilizes a slow curing melamine or other laminating resin that cures more slowly than a traditional melamine resin. Use of slower curing resins permits the center layers to reach cure temperature when multiple layers of the impregnated grass or grass blend sheets are used to make a thicker panel, which in turn ensures complete curing of the impregnant of the centermost sheets. This use of slow curing resin is in contrast to the fast curing melamine resins used in conventional prior art processes where a single layer of the melamine impregnated paper is assembled as the decorative surface layer over a core of numerous layers of kraft paper impregnated with phenolic resins. Thus, according to the present novel compact laminate, the multiple layers of resin impregnated sheets are consolidated under heat and pressure into an extremely strong, solid, homogenous laminated monolithic mass.

When the present novel compact laminate is practiced in a low pressure process, the pressure may be in the range of about 200 psi or less to as much as about 300 psi or more. The low pressure process may also use more use more resin than the high pressure process to ensure sufficient resin flow within the sheets to consolidate the sheets into the extremely strong, solid, homogenous laminated monolithic mass. In general, resin usage is minimized; however, lower pressures require more resin to ensure sufficient flow within the sheets.

The fully cured laminated assembly is optionally cooled while still under pressure to ensure that the panels resist warp while cooling and remain flat. For example, when the press is a type having a cooling cycle, the assembly is optionally cooled down to about 100 degrees F. while still under pressure in the press. Otherwise, the assembly is optionally removed hot from the press and stacked on a cooling slab under sufficient load to hold the panels flat while they cool. Fans may be utilized to accelerate the cooling process.

After cooling, the resultant laminates are separated, trimmed and packaged. Thinner sections of the novel laminates disclosed herein having only one or a few sheets of the resin impregnated grass or grass blend paper are optionally utilized similarly to the thin decorative surface layers of the prior art and bonded to thicker self-supporting substrates or core layers to form self-supporting panels. Else, thicker sections having multiple layers of the resin impregnated grass or grass blend paper are self-supporting and are optionally utilized as stand alone panels replacing the traditional compact laminates of the prior art.

The novel compact laminates disclosed herein have a compressive strength of 50,000 psi and can be cut, routed, sanded and finished with typical woodworking tools, much like butcher block style surfaces for either creating a new panel, or repairing an existing one.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A consolidated laminated article, comprising at least one paper sheet impregnated with a substantially completely cured resinous composition, the paper sheet comprising a grass fiber.

2. The article of claim 1 wherein the grass fiber further comprises a bamboo fiber.

3. The article of claim 1 wherein the paper sheet further comprises a wood fiber.

4. The article of claim 3 wherein the wood fiber further comprises a recycled wood fiber.

5. The article of claim 1 wherein the resinous composition further comprises a melamine resin.

6. The article of claim 5 wherein the melamine resin further comprises an aqueous melamine/formaldehyde resin solution.

7. The article of claim 6 wherein the aqueous melamine/formaldehyde resin solution further comprises a slow curing melamine resin.

8. The article of claim 1, further comprising a plurality of the paper sheet impregnated with a substantially completely cured resinous composition, the plurality of paper sheets being stacked in a superimposed relationship and laminated monolithic mass.

9. A compact laminated assembly, comprising a plurality of saturation grade paper sheets each comprising at least one grass fiber and being substantially impregnated with a curable laminating resin, and the plurality of saturation grade paper sheets being laminated into a substantially homogenous monolithic mass with the laminating resin being substantially completely cured.

10. The assembly of claim 9 wherein the curable laminating resin further comprises a thermosetting resin.

11. The assembly of claim 10 wherein each of the plurality of saturation grade paper sheets further comprises a blend of the grass fiber with a wood fiber.

12. The assembly of claim 11 wherein the wood fiber further comprises a recycled wood fiber.

13. The assembly of claim 10 wherein the thermosetting resin further comprises a thermosetting resin selected from the group of thermosetting resins consisting of a phenol/formaldehyde resin, a melamine/formaldehyde resin, and a urea/formaldehyde resin.

14. The assembly of claim 13 wherein the melamine/formaldehyde resin further comprises a slow curing melamine resin.

15. A compact laminated assembly, comprising:
a plurality of saturation grade paper sheets each comprising at least one grass fiber and being stacked in a superimposed relationship;
a thermosetting resin substantially impregnating each of the plurality of saturation grade paper sheets; and
the plurality of saturation grade paper sheets being heat and pressure consolidated into a substantially homogenous monolithic mass with the thermosetting resin being substantially completely cured.

16. The assembly of claim 15 wherein the thermosetting resin further comprises a thermosetting resin selected from the group of thermosetting resins consisting of: a phenol/formaldehyde resin, a melamine/formaldehyde resin, a urea/formaldehyde resin, and a mixture thereof.

17. The assembly of claim 16 wherein each of the plurality of saturation grade paper sheets further comprises a blend of the grass fiber and at least one wood fiber selected from the group of wood fibers consisting of a virgin wood fiber, and a recycled wood fiber.

18. The assembly of claim 17 wherein the grass fiber further comprises a bamboo grass fiber.

19. The assembly of claim 18 wherein the blend of grass and wood fibers further comprises a blend of substantially one half bamboo grass fibers and one half wood fibers.

20. The assembly of claim 19 wherein the melamine/formaldehyde resin further comprises a 100 percent aqueous melamine/formaldehyde resin solution comprising a slow curing melamine resin.
